(19) United States
(12) Patent Application Publication
(10) Pub. No.: US 2009/0108540 A1
(43) Pub. Date: Apr. 30, 2009

(54) Seal cartridge for a vacuum pumps

(75) Inventors: Kaye G. Kolb, JR., Owings Mills, MD (US); Brian L. Fisher, Finksburg, MD (US)

Correspondence Address: WILLIAM S RAMSEY, ESQ, 5253 EVEN STAR PLACE, COLUMBIA, MD, 21044, US

(73) Assignee: Advanced Vacuum Company Inc., Westminster, MD (US)

(21) Appl. No.: 12/074,564

(22) Filed: Mar. 5, 2008

Related U.S. Application Data
(60) Provisional application No. 60/905,124, filed on Mar. 6, 2007.

(51) Int. Cl. F16J 15/32

(52) U.S. Cl. 277/562

(57) ABSTRACT

An exemplary embodiment providing one or more improvements includes a shaft seal cartridge for the motor shaft of a vacuum pump which combines three shaft seals in one unit. The cartridge greatly simplifies the replacement of seals and eliminates the requirement for expensive seal lubrication oil, and extends the life of the shaft seals. Embodiments of the cartridge are manufactured from fiberglass/molybdenum filled polytetrafluoroethylene.

### CROSS-REFERENCES TO RELATED APPLICATIONS

This application claims priority to provisional application No. 60/905,124 filed Mar. 6, 2007.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### REFERENCE TO A “SEQUENCE LISTING,” A TABLE, OR A COMPUTER PROGRAM LISTING APPENDIX

Not Applicable.

### BACKGROUND

### Description of Related Art Including Information Disclosed Under 37 CFR 1.97 and 37 CFR 1.98

Embodiments of the present invention relate to improving the shaft seal design on mechanical vacuum boosters such as those manufactured by Edwards Vacuum of Crawley, England. Such booster are used in conjunction with vacuum pumps to create process vacuum for a variety of applications in a variety of industries, for example, the semiconductor manufacturing industry. The systems typically achieve an ultimate vacuum as low as 5.3×10⁻³ torr with displacements of from 30 to 845 ft³/minute.

Embodiments of the present application include a monolithic cartridge seal which includes a cylindrical polytetrafluoroethylene (PTFE) body with three seal lips on the interior surface. These embodiments seal the rotating motor shaft which activates a lobe-type booster vacuum pump. This cartridge seal replaces the conventional three single lip VITON seals on vacuum booster pumps and avoids the air and oil leakage which plagues such seals.

U.S. Pat. No. 3,420,535 discloses a seal which may be constructed of PTFE which comprises two parts, one which is attached to the mount and does not rotate, the other attached to the shaft and rotates with the shaft with a sealing surface which bears on the immobile surface.

U.S. Pat. No. 3,801,114 discloses a seal comprising three PTFE washers clamped in a metal case which uses hydrodynamic forces to return oil which may have leaked past the first seal.

U.S. Pat. No. 4,383,691 discloses a PTFE seal with an hydrodynamic arrangement of wind-back ribs which exclude the leakage of fluids through the seal. A rib-free area prevents leakage through the seal when the shaft is static.

U.S. Pat. No. 4,522,411 discloses a pumping seal for vacuum pumps with an elastomeric primary lip and a PTFE auxiliary lip.

U.S. Pat. No. 4,828,273 discloses a seal for a lead-through for a vacuum chamber with a PTFE sleeve, the sleeve sealed to the bore and shaft by elastomeric rings.

U.S. Pat. No. 4,850,601 discloses individual PTFE seals which seal on a circumferential surface having a sealing chamber which is force fitted onto a shaft. FIGS. 9-11 are not described in the specification.

U.S. Pat. No. 5,368,648 discloses PTFE seals used to seal chamber walls in semiconductor manufacture.

U.S. Pat. No. 5,984,316 discloses a variety of single PTFE seals which are C shaped and contain a metal ring at the top of the C and a coil spring below it.

U.S. Pat. No. 6,676,132 discloses a metal coil inverted L shaped in cross section with PTFE coating on the upper surface extending to form a main and an auxiliary seal which seals to the shaft. A garter spring urges the seals against the shaft. The use of multiple sealing units is disclosed.

Pub. Pat. Appl. 2005/0264791 discloses a rotating seal for a vacuum chamber which can be elastomer, or ferrofluidic.

The shaft seal cartridge of the present application has a number of advantages over the prior art seals which meet long-felt needs. Use of the cartridge eliminates the need for keeping the shaft seal oil reservoir filled with perfluoronated polyether PFPE-based oil. This prevents the possibility of sucking the oil into the vacuum pump and eliminates the cost of securing the expensive oil as well as the cost of disposing of the used oil, which is regarded as hazardous waste. Furthermore, the labor cost of maintaining the pump is reduced by eliminating the monitoring and maintaining of the oil level and of the periodic replacement of the oil. Another unexpected advantage is the reduction of skilled labor involved in the periodic replacement of the shaft seals due to the longer life of the cartridge seal and the simplicity of replacement, compared to the conventional energized lip seals. Finally, the cartridge seal is used with two cylindrical shaft sleeves, as opposed to the prior art seals which require a conical sleeve and a cylindrical sleeve, which allows a cost saving and reduction of parts inventory.

The foregoing examples of the related art and limitations related therewith are intended to be illustrative and not exclusive. Other limitations of the related art will become apparent to those of skill in the art upon a reading of the specification and a study of the drawings.

### BRIEF SUMMARY

Embodiments include shaft seal cartridges for vacuum pumps which comprise a cylindrical shaft seal cartridge having an outer surface and an inner surface, the cartridge comprised of a cylindrical seal cartridge shoulder, the shoulder having a shoulder seal notch around the circumference of the outer surface and an atmosphere lip around the circumference of the inner surface. A cylindrical seal body is attached to the shoulder, the body having a body seal notch around the circumference of the outer surface and a vacuum lip around the circumference of the inner surface, the vacuum lip adjacent to the atmosphere lip, and an oil lip around the circumference of the inner surface, the oil lip adjacent to the vacuum lip. The shoulder has a greater diameter than the body.

In addition, embodiments of the shaft seal cartridge for vacuum pumps of further comprises an outer O-ring seal located in the shoulder seal notch and an inner O-ring seal in the body seal notch.

Embodiments include shaft seal cartridges for vacuum pumps wherein the cartridge is manufactured of a single piece of material.

The following embodiments and aspects thereof are described and illustrated in conjunction with systems, tool and methods which are meant to be exemplary and illustrative, not limiting in scope. In various embodiments, one or more of the above-described problems have been reduced or eliminated, while other embodiments are directed to other improvements.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a cross-section of prior art seals installed in a vacuum pump.

FIG. 2 is a perspective view of an embodiment shaft seal cartridge with the shoulder rim in the foreground.

FIG. 3 is a perspective view of an embodiment shaft seal cartridge with the body rim in the foreground.

FIG. 4 is a cross-section of a portion of an embodiment shaft seal cartridge taken at line 4-4 of FIG. 1.

FIG. 5 is a cross-section of an embodiment shaft seal cartridge installed in a vacuum pump.

### DETAILED DESCRIPTION

Embodiments of the present invention relate to improving the shaft seal design on mechanical vacuum boosters such as those manufactured by Edwards Vacuum of Crawley, England. Such booster are used in conjunction with vacuum pumps to create process vacuum for a variety of applications in a variety of industries, for example, the semiconductor manufacturing industry. The systems typically achieve an ultimate vacuum as low as 5.3×10⁻³ torr with displacements of from 30 to 845 ft³/minute.

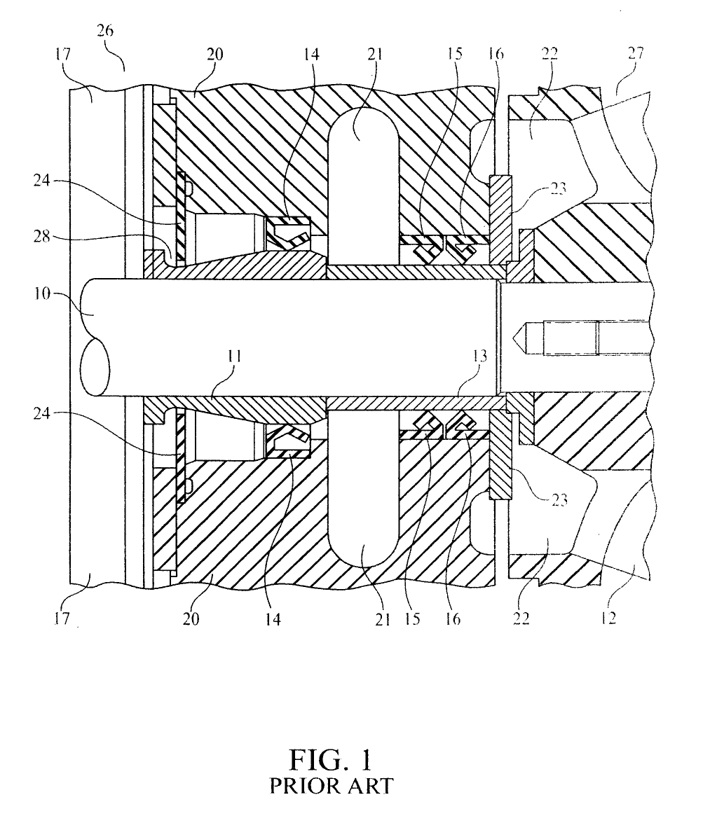

FIG. 1 is a cross-section illustration of a prior art shaft seal design employed by Edwards Vacuum on its model EH250, EH500, EH1200, QMB250, QMB500 and QMB1200 and all variations thereof boosters. Visible in FIG. 1 is the pump motor 17 with its shaft 10. Covering the shaft 10 are two force-fitted sleeves, a conical sleeve 11 and a cylindrical sleeve 13. The sleeves provide a wear-resistant yet replaceable surface for the rotating motor shaft 10. A shaft seal housing bore 28 penetrates the shaft seal housing 20. The shaft with associated sleeves is inserted through the shaft seal housing bore 28 through the shaft seal housing 20. The shaft seal housing 20 contains the three VITON lip seals 14, 15, 16 and the housing outer seal ring and housing inner seal ring 23. VITON is a trademark for synthetic rubber and rubber compositions owned by E. I. Du Pont De Nemours & Company, Wilmington, Del. The first VITON lip seal 14 is a ring seal with a lip which bears on the conical sleeve 11. The second VITON lip seal 15 is a ring seal with a lip which bears on the cylindrical sleeve 13. The third VITON lip seal 16 is a ring seal with a lip which bears on the cylindrical sleeve 13. The shaft seal housing 20 also contains a shaft seal oil reservoir 21. The shaft 10 extends through the shaft seal housing 20 into the gear box 12 which includes a coupling enclosure oil reservoir 22. In FIG. 1 the atmosphere side 26 is at the left or outer side of the shaft seal housing 20 and the vacuum side 27 is to the right or inner side of the shaft seal housing 20. The shaft seal reservoir is also at atmospheric pressure.

The current prior art seals design fails on average after up to 5 years of normal use, with a high number of failures after less than one year use. Such failures result from premature shaft seal failure which allows oil to leak from the shaft seal oil reservoir 21 either to the exterior of the booster (to the atmosphere side 26) through the first lip seal 14 shaft seal or into the hydrostatic drive oil reservoir 22 (which is on the vacuum side 27) through the second lip seal 15 and the third lip seal 16. This occurs when one or both of the seals 15 and 16 fail. The shaft seal reservoir 21 contains oil and is designed to lubricate the first lip seal 14 and the second lip seal 15 during operation. The shaft seal reservoir 21 is at atmospheric pressure. Once the oil is no longer present in the shaft seal reservoir 21, the seals no longer receive any lubrication, and air is drawn into the hydrostatic drive oil reservoir 22 as a result of the pressure differential created by the vacuum. This causes the pressure to rise in the vacuum side 27 and results in an internal leak which causes the unit to cease to operate.

Failure of one or more of the prior art seals necessitates drainage and replacement of the PTFE-oil and hydrostatic drive oil and replacement of the lip seals in addition to a complete rebuild of the booster and likely the dry backing pump as well. This requires detachment of the shaft seal housing from the motor and from the gear box. The first lip seal is removed and replaced from the atmosphere side of the shaft seal housing while the second and third lip seals are removed and replaced from the vacuum side of the shaft seal housing. Each lip seal must be accurately seated to insure that the seal lip is perpendicular to the sleeve upon which the seal bears over the entire circumference of the sleeve. Such seating is obtained using a tool specifically dimensioned for each seal.

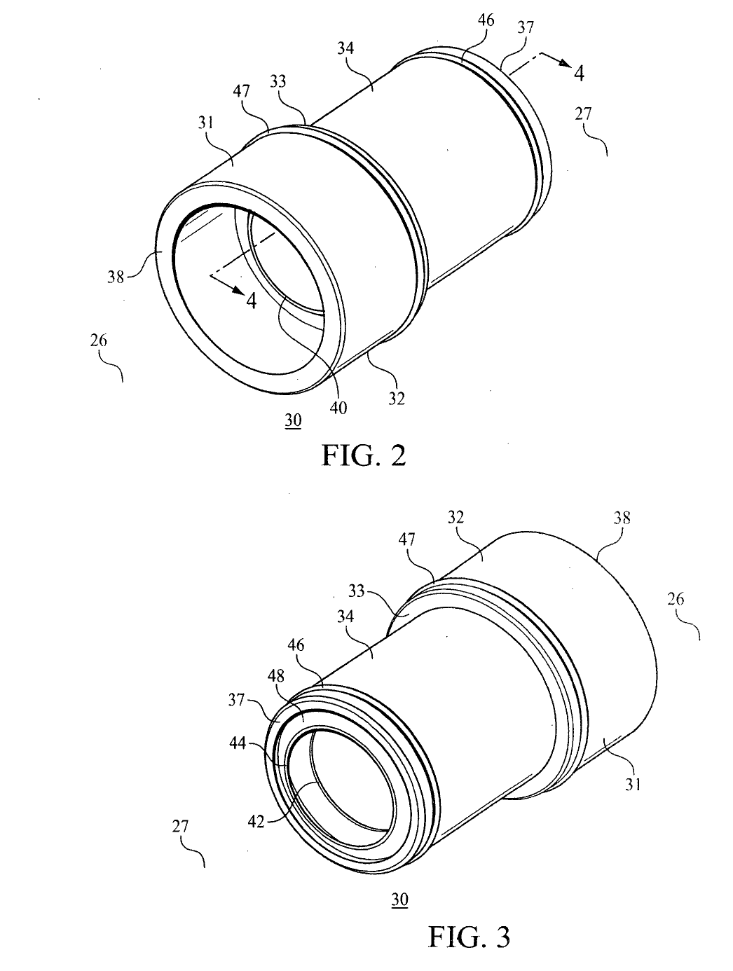

FIG. 2 is a perspective view of an embodiment shaft seal cartridge 30 of the present application with the shoulder or outer rim 38 in the foreground. The cartridge is installed in the pump with the atmosphere side 26 to the left of FIG. 2 and the vacuum side 27 to the right in FIG. 2. The cartridge 30 is comprised of a seal body shoulder 32 attached to smaller external diameter reservoir wall 34. A seal body step 33 is on the vacuum side of the shoulder 32. The outer rim 38 of the shoulder 32 is indicated, and the reservoir wall or inner rim 37 of the reservoir wall 34 is indicated but not visible on the vacuum side 27 of FIG. 2. The atmosphere lip seal 40 is visible on the circumference of the inner surface 31 of the seal body shoulder 32. A shoulder O-ring seal 47 is visible on the external circumference of the shoulder 32 and a reservoir wall O-ring seal 46 is visible on the external circumference of the reservoir wall 34. The O-ring seals fit into O-ring grooves not shown in FIG. 2.

FIG. 3 is a perspective view of an embodiment shaft seal cartridge 30 of the present application with the reservoir wall or inner rim 37 in the foreground. The cartridge is installed in the pump with the vacuum side 27 to the left of FIG. 3 and the atmosphere side 26 to the right in FIG. 3. The cartridge 30 is comprised of a seal body shoulder 32 attached to smaller external diameter reservoir wall 34. A seal body step 33 is on the vacuum side of the shoulder 32. The outer rim 38 of the shoulder 32 is indicated but not visible in FIG. 3, and the inner rim 37 of the reservoir wall 34 is visible on the vacuum side 27 of FIG. 3. The oil lip seal 44 is visible on the circumference of the inner surface 48 of the reservoir wall 34. The vacuum lip seal 42 is visible on the circumference of the inner surface 48 of the reservoir wall 34. A shoulder O-ring seal 47 is visible on the external circumference of the shoulder 32 and a reservoir wall O-ring seal 46 is visible on the external circumference of the reservoir wall 34. The O-ring seals fit into O-ring grooves not shown in FIG. 3.

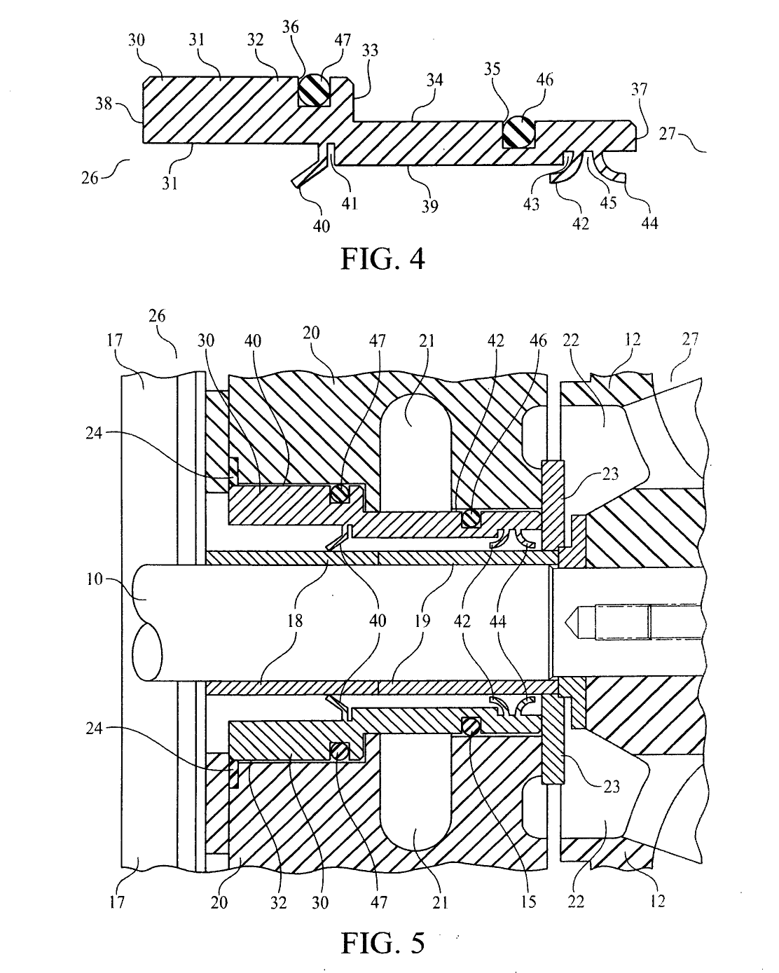

FIG. 4 is a cross-section of a portion of an embodiment shaft seal cartridge 30 taken at line 4-4 of FIG. 2. Visible in FIG. 4 on the outer surface of the cylindrical seal cartridge is a shoulder or outer rim 38, seal body shoulder 32, shoulder O-ring seal 47 which rests in a shoulder O-ring groove 36, seal body step 33, reservoir wall 34, reservoir wall O-ring seal 46 which rests in a reservoir wall O-ring groove 35, and reservoir wall or inner rim 37. Visible in FIG. 4 on the inner surface of the cylindrical seal cartridge is the shoulder inner surface 31, atmosphere lip seal 40, atmosphere lip seal notch 41, reservoir wall inner surface 39, vacuum lip notch 43, vacuum lip seal 42, oil lip notch 45, and oil lip seal 44. In FIG. 4 the atmosphere side 26 is on the left side and the vacuum side 27 is on the right side. Embodiments of the shaft seal cartridge include a bidirectional one piece seal which replaces the previously used three separate oil lubricated VITON lip seals. Embodiments of the shaft seal cartridge do not require lubrication for operation.

Operation of embodiments of the shaft seal cartridge does not require use of oil in the shaft seal oil reservoir as the lip seals operate without lubrication. In FIG. 4 the atmosphere lip seal 40 and the vacuum lip seal 42 are inclined toward the atmosphere side 26. The oil lip seal 44 is inclined toward the vacuum side. The atmosphere lip seal notch 41, vacuum lip seal notch 43, and oil lip seal notch 45 are undercuttings which insure the optimum flexibility of the respective lip seals.

FIG. 5 is a cross-section of an embodiment shaft seal cartridge installed in a vacuum booster pump. Features of the motor, motor shaft, shaft seal housing, and gear box are as in FIG. 1. Also visible in FIG. 5 is an outer cylindrical sleeve 18 and inner cylindrical sleeve 19. The sleeves are force fitted on the motor shaft 10 and rotate with the motor shaft. An embodiment shaft seal cartridge 30 is shown in place with the atmosphere lip seal 40 resting on the circumference of the outer cylindrical sleeve 18 and the vacuum lip seal 42 and oil lip seal 44 resting on the circumference of the inner cylindrical sleeve 19. Also visible is the shoulder O-ring 47 seal and reservoir wall O-ring 46 seal which seal the area between the shaft seal housing 20 and the shaft seal cartridge shoulder 32 and reservoir wall 34. The shaft seal cartridge 30 does not rotate.

Replacement of a shaft seal cartridge is required when the seals are worn. The motor 17 and shaft 10 with associated sleeves 18 and 19 are detached from the shaft seal housing 20. The shaft seal cartridge is withdrawn. A new shaft seal cartridge 30 is inserted in the shaft seal housing bore 28 with the shoulder step 33 adjacent to the seal housing step 25. The motor 17 and shaft 10 with replacement sleeves 18 and 19 are reinserted into the shaft seal housing bore 28 and the motor reattached to the shaft seal housing. This is usually performed only during the complete rebuild of the booster.

Embodiments include a shaft seal design which has been created to improve the reliability and mean time between failure of Edwards Vacuum model EH250, EH500, EH1200, QMB250, QMB500 and QMB1200 mechanical boosters and all variations thereof. The shaft seal design converts the existing three separate oil lubricated VITON lip seals used on the drive side of the boosters to a one piece filled PTFE design which does not require lubrication and is suitable for use in vacuum service. There are two sizes of the seal, size EDD-FL2054 which is the smaller size and is applicable to the booster models containing the numbers 250 and 500, and the larger sized EDD-FL2055 which is applicable to booster models containing the number 1200.

Embodiments of the shaft seal cartridge are manufactured of virgin PTFE resin with filler materials added in varying percentages to improve the physical properties of the virgin PTFE resin. The blended alloy is currently glass/molybdenum filled PTFE resin however other suitable materials are contemplated. Embodiments include 90% virgin PTFE resin with 5% fiberglass and 5% MoS₂ all percentages by weight. Other embodiments include 80% to 98% virgin PTFE resin with 1% to 10% fiberglass and 1% to 10% MoS₂, all percentages by weight. Other embodiments include PTFE resin, PTFE resin filled with a mixture of carbon and graphite, PTFE resin filled with molybdenum, PTFE resin filled with polyimide, or PTFE resin filled with bronze.

In the manufacture of embodiments the blended raw material is compression molded at room temperature inside a cylindrical mold. This creates a fragile sleeve or billet of raw material that will be sintered in an oven for 16-30 hours. The time in the oven is a slow cycle of temperature change from ambient to over 700 degrees Fahrenheit and back to ambient. This process is critical to producing a sleeve that possesses the physical properties necessary for the machined shaft seal cartridge to function in the application.

Although embodiments have been disclosed in which the shaft seal cartridge is manufactured from a single monolith sleeve, it is also possible that the cartridge be manufactured in several pieces. The pieces can be shaped and then combined using adhesive means, or the cartridge can be used in several pieces, each piece with at least one lip seal on the inner surface.

Embodiments of the shaft seal cartridges are made on a computer numerical control (CNC) lathe. Unique CNC programs have been written and saved for repeatability. A sleeve of PTFE alloy is loaded into the lathe for machining. Typically a collet will be used to hold the sleeve. One sleeve will typically make 4-5 pieces of seal of this size. The key indicator of seal life and impending failure is seal lip thickness. In the case of a seal with nominal seal lip thickness of 0.032 inches, testing after 90 days of continuous use resulted in a seal thickness of 0.0318 inches. It is estimated that a seal with the lip design of certain embodiments tested will last at least five years in normal use, depending on actual operating conditions.

After the new seal is installed, the requirement for oil filling of the shaft seal oil reservoir is now optional. The seal itself does not require lubrication, and is designed to run dry. Filling the shaft seal oil reservoir with oil will not affect the seal operation because the oil will be shielded from the seal by the outer diameter of the seal cartridge.

Use of embodiments of the present application have a number of advantages over the prior art. Since there is no requirement for PFPE based lubricating oil to lubricate the seals, there is a saving of the cost of obtaining the oil and disposal or reclaiming of the used oil, as well as the labor cost for monitoring and replacing the oil. Replacement of the shaft seal cartridge when necessary requires less disassembly of the pump and less labor than replacement of the three prior art seals. Finally, the shaft seal cartridge requires replacement less often than the prior art seals.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

I claim:

1. A shaft seal cartridge for vacuum booster pumps comprising:
A cylindrical shaft seal cartridge having an outer surface and an inner surface, the cartridge comprised of:
a cylindrical seal cartridge shoulder,
the shoulder having a shoulder seal notch around the circumference of the outer surface and an atmosphere lip around the circumference of the inner surface, and
a cylindrical seal body,
the body having a body seal notch around the circumference of the outer surface and a vacuum lip around the circumference of the inner surface, the vacuum lip adjacent to the atmosphere lip, and an oil lip around the circumference of the inner surface, the oil lip adjacent to the vacuum lip, and
the shoulder having a greater diameter than the body.

2. The shaft seal cartridge for vacuum booster pumps of claim 1 further comprising an outer O-ring seal located in the shoulder seal notch and an inner O-ring seal in the body seal notch.

3. The shaft seal cartridge for vacuum booster pumps of claim 1 wherein the cartridge is manufactured of a single piece of material.

4. The shaft seal cartridge for vacuum booster pumps of claim 1 wherein the cartridge is manufactured of two or more pieces of material.

5. The shaft seal cartridge for vacuum booster pumps of claim 1 wherein the cartridge is manufactured of polytetrafluoroethylene resin filled with a mixture of glass and molybdenum.

6. The shaft seal cartridge for vacuum booster pumps of claim 1 wherein the material of manufacture is 90% virgin polytetrafluoroethylene resin filled with 5% fiberglass and 5% MoS₂, all percentages by weight.

7. The shaft seal cartridge for vacuum booster pumps of claim 1 wherein the material of manufacture is 80% to 98% virgin polytetrafluoroethylene resin filled with 1% to 10% fiberglass and 1% to 10% MoS₂, all percentages by weight.

8. The shaft seal cartridge for vacuum booster pumps of claim 1 wherein the material of manufacture is virgin polytetrafluoroethylene resin, polytetrafluoroethylene resin, polytetrafluoroethylene resin filled with a mixture of carbon and graphite, polytetrafluoroethylene resin filled with molybdenum, polytetrafluoroethylene resin filled with polyimide, or polytetrafluoroethylene resin filled with bronze.

9. The shaft seal cartridge for vacuum booster pumps of claim 1 wherein the cartridge is installed in a vacuum pump with the shoulder nearest the atmosphere side of the pump and the body side nearest the vacuum side of the vacuum booster pump.

10. The shaft seal cartridge for vacuum booster pumps of claim 1 wherein the cartridge is installed in a vacuum pump with the atmosphere lip and the vacuum lip is oriented toward the atmosphere side of the pump and the oil lip is oriented toward the vacuum side of the vacuum booster pump.
